(19) United States
(12) Patent Application Publication
(10) Pub. No.: US 2009/0301735 A1
(43) Pub. Date: Dec. 10, 2009

(54) REMOTE CONTROLLED NOZZLE CHANGER

(75) Inventor: James M. Trapp, Galien, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: ELKHART BRASS MANUFACTURING COMPANY, INC., Elkhart, IN (US)

(21) Appl. No.: 12/478,507

(22) Filed: Jun. 4, 2009

Related U.S. Application Data
(60) Provisional application No. 61/059,296, filed on Jun. 6, 2008.

(51) Int. Cl. A62C 31/05; A62C 31/02; G05D 7/00

(52) U.S. Cl. 169/5; 169/13; 137/565.27; 137/861

(57) ABSTRACT

A fire fighting fluid delivery device includes a device body with an inlet, a discharge outlet, and a fluid passageway extending between the inlet and the discharge outlet. A movable member is mounted at the body and movable between at least two positions relative to the outlet. The movable member includes at least two spaced apart transverse openings, with each of the transverse openings for selectively aligning with the discharge outlet when the movable member is moved between the at least two positions.

### TECHNICAL FIELD AND BACKGROUND OF THE INVENTION

The present invention relates to a fire fighting fluid delivery device and, more particularly, to a nozzle changer for a fire fighting fluid delivery device.

In the field of fire fighting, vehicles are being developed with multiple suppression systems, with each system discharging agents with markedly different physical characteristics. However, these differing agent characteristics result in the need for different nozzles, depending on the agent system in use. Conventional devices for discharging fire fighting fluid delivery devices, such as monitors, typically have one nozzle. Therefore, in systems that use multiple agents with different physical characteristics when a different fluid used, in order to optimize the flow, the flow is stopped and the nozzle replaced on the fighting fluid delivery device or devices. This takes time. When time is critical any delay could result in more damage. Further, some devices are operated remotely, such as remote control monitors, and therefore when a nozzle change-out is required even further delays can be experienced; therefore, more typically multiple monitors are used.

Accordingly, there is a need for a fire fighting fluid delivery device that may be adapted to apply different agents.

### SUMMARY OF THE INVENTION

Accordingly, the present invention provides a fire fighting fluid delivery device that is adapted to deliver different agents so that a single fire fighting fluid delivery device may be used to supply different discharging agents and, further, different discharging agents with markedly different physical characteristics.

In one form of the invention, a fire fighting fluid delivery device includes a device body with an inlet, an outlet, and a fluid passageway extending between the inlet and the outlet and a remotely controlled nozzle changer that is mounted at the body and which includes at least two nozzles movable.

In another form of the invention, a fire fighting fluid delivery device includes a device body with an inlet, an outlet, and a fluid passageway extending between the inlet and the outlet and a movable member mounted at the body and which is movable between at least two positions relative to the outlet of the body. The movable member includes at least two spaced apart transverse openings, with each of the transverse openings for selectively aligning with the discharge outlet when the movable member is moved between the at least two positions.

In one aspect, the fire fighting fluid delivery device further includes a coupler, such as a threaded coupler, mounted at each of the transverse openings, which are adapted for mounting nozzles to the movable member. In a further aspect, a piston is provided at the outlet, which forms a seal with the device body at the outlet. The movable member is mounted over the piston, and the piston is configured to move and seal around the inlet opening of a respective coupler when the respective coupler is aligned with the outlet and fluid flows through the device body to thereby provide a seal between the respective coupler and the device body.

In yet other aspects, the movable member is mounted generally orthogonal to the discharge outlet. Further, the movable member may be mounted for linear movement across the discharge outlet. Additionally, the movable member may be mounted for horizontal linear movement.

According to yet other aspects, the movable member may include stops for delineating when a respective transverse opening is aligned with the outlet.

Other aspects include an actuator for selectively moving the movable member. For example, the actuator may comprise a cylinder, such as a pneumatic or hydraulic cylinder, or an electrical actuator.

Further, the actuator may be coupled to a control system to provide remote or automatic control of the position of the movable member so that when different nozzles are mounted to the couplers of the movable member that different nozzles may be provided at the outlet of the fire fighting fluid delivery device.

According to yet another aspect, the fire fluid delivery device includes bearings at the outlet, which support the movable member for movement relative to the outlet.

Accordingly, the fire fighting fluid delivery device of present invention can have its nozzle changed between two or more nozzles remotely or automatically, or even manually, so that it may deliver agents or a different flow shapes with relative ease.

These and other objects, advantages, purposes, and features of the invention will become more apparent from the study of the following description taken in conjunction with the drawings.

### DESCRIPTION OF THE DRAWINGS

FIG. 1 is a perspective view of a fire fighting fluid delivery device of the present invention;

FIG. 2 is an elevation view of the fire fighting fluid delivery device of FIG. 1;

FIG. 3 is a top plan view of the fire fighting fluid delivery device of FIG. 2;

FIG. 4 is another elevation view of the fire fighting fluid delivery device of FIG. 1;

FIG. 5 is a cross-section view taken along line V-V of FIG. 4; and

FIG. 6 is an enlarged cross-section view taken along line VI-VI of FIG. 4.

### DETAILED DESCRIPTION OF THE PREFERRED EMBODIMENTS

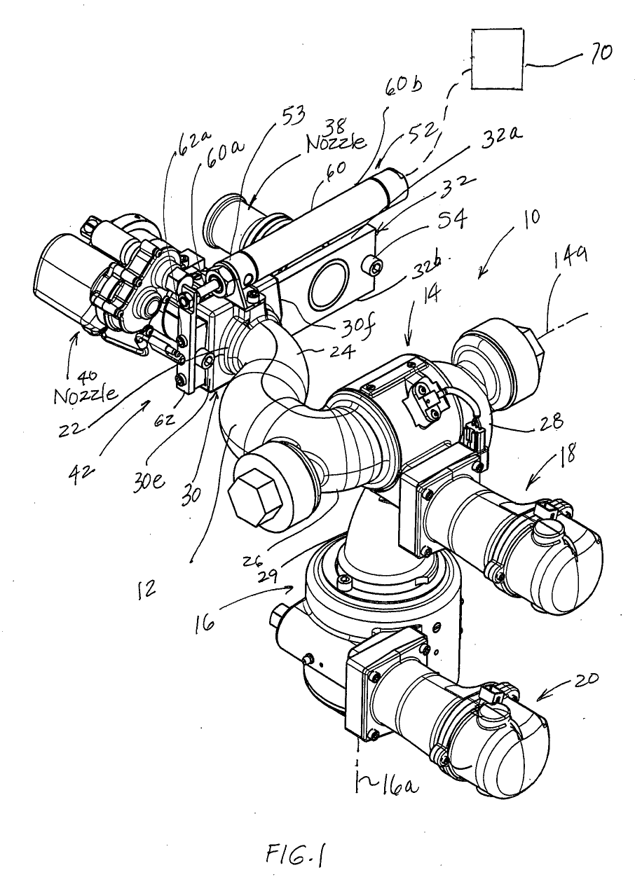

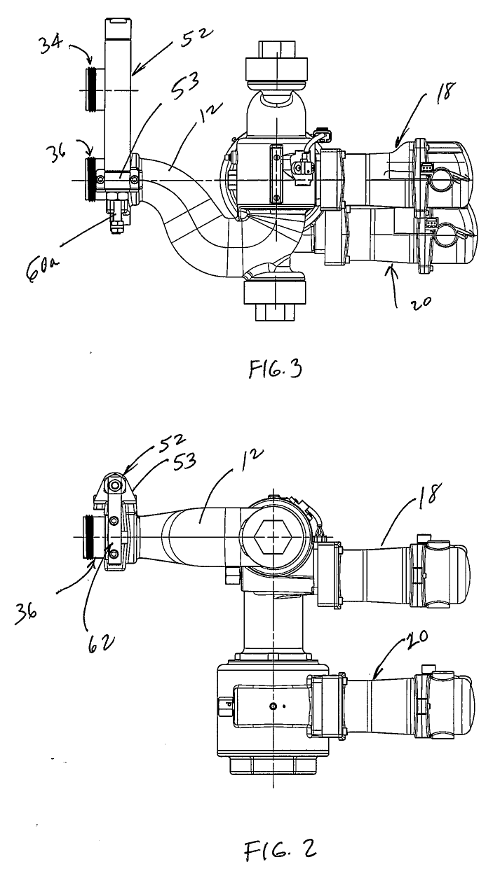

Referring to FIG. 1, the numeral 10 generally designates a fire fighting fluid delivery device of the present invention. In the illustrated embodiment the fire fighting fluid delivery device comprises a fire fighting monitor 10 with a device body 12, which may include one or more swivel connections or joints to form one or more articulating sections that define, for example, a horizontal pivot axis 14a around a first swivel joint 14 and a vertical pivot axis 16a around a second swivel joint 16. Further, monitor 10 may incorporate actuators, such as electric actuators 18 and 20, for rotating the articulating sections of the monitor about their respective axes. For further details of swivel joints 14 and 16 and actuators 18 and 20, reference is made herein to co-owned U.S. Pat. No. 7,191,964 entitled FIRE FIGHTING MONITOR WITH REMOTE CONTROL, which is assigned to Elkhart Brass Manufacturing Company, Inc. of Elkhart, Ind., which is incorporated herein in its entirety by reference. As will be more fully described below, outlet 22 of monitor 10 is adapted to discharge agents with markedly different physical characteristics or in the alternative to provide discharges with markedly different characteristics.

In the illustrated embodiment, device body 12 is formed from an elbow pipe section 24, an intermediate U-shaped pipe section 26, and another generally U-shaped pipe section 28, and a second elbow pipe section 29, all in fluid communication with each other and with outlet 22 of body 12 provided at the distal end of elbow pipe section 24. Elbow pipe section 24 and U-shaped pipe section 26 are coupled to U-shaped pipe section 28 through swivel connection 14, which in turn is mounted to a truck, or to a base, by elbow pipe section 29 and swivel connection 16 to thereby form a portable monitor. As understood from the description above and drawings, swivel connection 16 provides a vertical pivot axis of body 12 at the connection to the truck, or base. In this manner, outlet 22 is pivotal about generally horizontal pivot axis 14a and vertical pivot axis 16a.

Formed or otherwise provided at the distal end of elbow pipe section 24 is a mount 30 for receiving a nozzle changer mechanism 42. Nozzle changer mechanism 42 includes a movable frame or member 32, which includes at least two transverse openings 32a and 32b in which a respective pair of couplers 34 and 36 are mounted and which are adapted to selectively align with outlet 22. Couplers 34 and 36 are adapted to receive and have mounted thereon a respective nozzle 38 and 40. Each nozzle 38, 40 may be configured to provide a certain configuration of discharge and/or configured for delivering a selected discharge agent, with the nozzles optionally configured to discharge fluids or agents with different physical characteristic so that monitor 10 may apply different agents and/or discharge agents with different discharge patterns.

As noted above, member 32 is movably supported in mounted member 30. In the illustrated embodiment, member 32 is mounted for lateral, generally horizontal movement with respect to outlet 22; but it should be appreciated that member 32 may be configured for rotary motion or transverse generally vertical movement relative to outlet 22, though with a vertical arrangement, the vertical range of motion of the monitor may be limited. In addition, while only two couplers are illustrated, it should be appreciated that more than two couplers may be provided to provide the ability to mount more than two nozzles at outlet 22.

In order to support member 32 for movement relative to outlet 22, mounting member 30 includes upper and lower linear bearings 44 and 46, which are positioned above and below member 32. In the illustrated embodiment, support member 32 comprises a generally rectangular plate with upper and lower edges 32a and 32b. Accordingly, bearings 44 and 46 are linear bearings and are positioned to support the opposed upper and lower edges of member 32 to thereby support member 32 for lateral, horizontal movement in mounting member 30. As would be understood for a rotary mounting arrangement the support member may be configured as a circular plate or may be configured as a segment of a circle plate, including, for example, a 90 degree section or semicircular plate. In which case the bearings may be configured as arcuate or annular bearings to thereby support the support member for rotational movement about a pivot point offset from the discharge outlet.

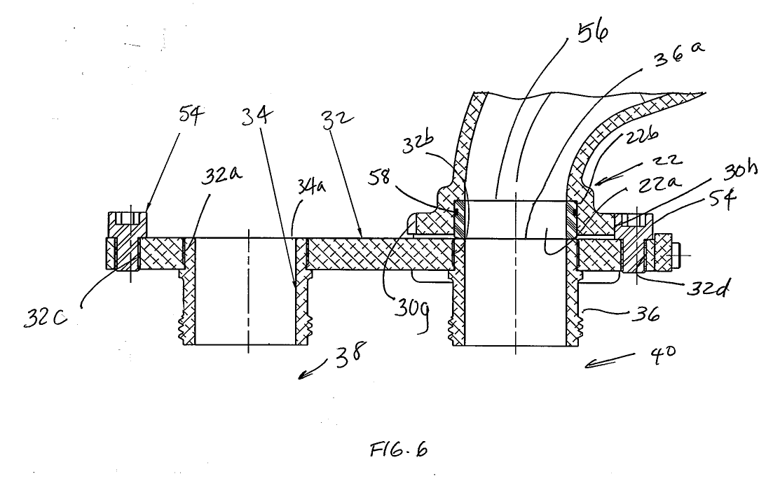

As best understood from FIGS. 1, 4 and 5, mounting member 30 has a generally C-shaped section with an upper horizontal arm or portion 30a and a lower horizontal arm or portion 30b, each with a channel or slot 48 and 50 for receiving the respective bearings 44 and 46. Upper arm 30 further includes a transverse portion 30c, which provides a mounting surface for the valve changer mechanism actuator 52, which will be more fully described below.

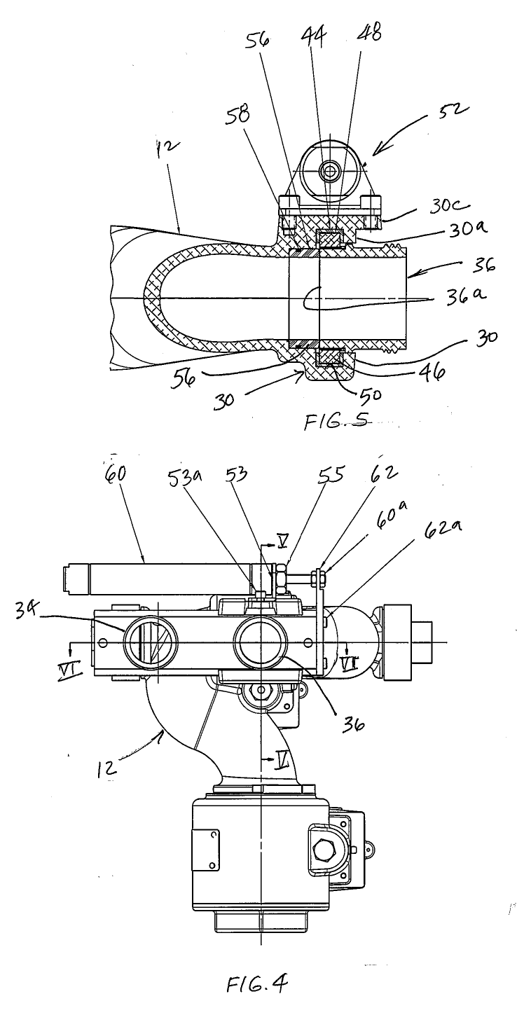

Member 32 is configured to have at least two distinct positions, one to the left as viewed in FIG. 4 and another to the right in which each of the respective couplers is aligned with the outlet 22. To that end, member 32 may include a pair of stops to provide the two distinct positions. In the illustrated embodiments, the stops are provided in the form of threaded stop screws 54 that extend through threaded openings 32c and 32d formed in member 32 at opposed ends of member 32. Thus each stop makes contact with a respective opposed edge 30e, 30f of mounting member 30 when sliding member 32 is moved to its fully extended position to the right or to the left depending on which nozzle is to be aligned with outlet 22. Further, the respective edges 30e and 30f of member 30 may each include a recess, such as an arcuate recess 30g and 30h to receive the respective head of the stop screws 54. Recesses 30g and 30h are dimensioned to provide for precise alignment between the monitor discharge outlet and one of the couplers when the corresponding stop screw is in contact with the recess.

In order to provide a seal between the outlet 22 and the respective coupler 34, 36 aligned with outlet 22, monitor 10 includes a piston 56. In the illustrated embodiment, piston 56 is mounted in outlet 22, which is located in a bore 22b formed, such as by machining, in outlet 22. When the desired nozzle is aligned with the monitor discharge outlet, the pressure resulting from the application of the suppression system within the monitor flow passage will serve to urge piston 56 toward and against the inlet end of the respective coupler 34, 36 to an engaged state to thereby seal again the respective coupler. For example, suitable piston material may include a polymer, such as an ultra high molecular weight polyethylene, or a metal with the piston provided with a separate elastomeric sealing surface affixed to the discharge end of the piston. Similarly, the piston 56 is sealed in bore 22 by an O-ring seal 58, which is located in an annular groove formed to the outer surface of piston 56. When the flow through the monitor is stopped, the piston is not longer urged into its engaged state and instead assumes a disengaged state since the pressure of the fluid flow is not longer applying pressure to the piston. However, it should be understood that a piston may be alternatively mounted exteriorly of the outlet with a portion of the fluid flowing through the monitor redirected through the pipe wall to thereby move the piston when fluid is flowing through the monitor. Alternately, the exteriorly mounted piston may be moved by other actuating means, such as an actuator.

As previously noted, sliding member 32 is moved by actuator 52. In the illustrated embodiment, actuator 52 comprises a cylinder 60, such as a pneumatic cylinder or hydraulic cylinder, which is mounted to transverse portion 30c of upper arm 30a of mounting member 30. The fluid is then delivered to cylinder 60 by conventional tubing from a pump (not shown), which may be mounted to or near the monitor. Its rod end 60a is secured to sliding member 32 by a coupler 62, which is secured, for example, to the distal end of sliding member 32 by a plurality of fasteners 62a. Housing 60b of cylinder 60 is mounted to member 30 at transverse portion 30c by a bracket 53. In this manner, when rod 60a is extended relative to the cylindrical housing 60b of cylinder 60, sliding member 32 is moved to the left as viewed in FIG. 1 until stop screw 54 abuts edge 30f of member 30 so that nozzle 34 may be aligned with outlet 22. Similarly, as shown, when rod 60a is retracted into housing 60b of cylinder 60, sliding member 32 is moved to the right until stop screw 54 is aligned with edge 30e of mounting member 30 at which time, nozzle 36 is then aligned with outlet 22. Further, it should be understood that an electric linear actuator or a push-pull cable control may be used in lieu of the cylinder. Therefore, with an electric actuator is used, similar to actuators 18 and 20, actuator 52 may be remotely actuated by a remote control 70 which is either electrically couple to the actuator via cabling or wiring or using RF signals so that the entire operation of monitor 10 may be remotely and optionally automatically controlled. Remote control may also be provided to actuate the pump in the case of a pneumatic or hydraulic cylinder. Alternately or in addition, the movable member may be manually moved.

Furthermore, as noted, the nozzle changer mechanism of the present invention may incorporate a rotary moving member and a rotary actuator to provide a rotational arrangement in lieu of the linear arrangement described herein. For example, the rotary member may comprise a disk or a disk segment, which is mounted to rotate about a fixed pivot point with the nozzle couplers or attachment members mounted to the disk and with the actuator coupled to the disk or disk segment to move the respective couplers between their respective positions.

While the fire fighting fluid delivery device of the present invention has been described in the context of a remote controlled monitor, a remote controlled monitor is just exemplary and therefore the term fire fighting fluid delivery device is used more broadly to include a variety of different fire fighting fluid delivery devices, including a manually controlled monitor, a fire hose, including a fire hose with a shut-off valve. Further, while the illustrated embodiment illustrates an integrated nozzle changer mechanism, it should be understood that the nozzle changer mechanism may be constructed separately from the fire fighting fluid delivery device and designed to attach an existing fire fighting fluid delivery device using conventional hose threads swivel connections. However, one advantage to having the changer mechanism integrated with the fire fighting fluid delivery device body is that any moment resulting from eccentric or cantilevered loads can be resisted by the fire fighting fluid delivery device assembly, where as with a separate changer assembly additional brackets may be required to maintain the changer in a desired rotational alignment.

As will be understood from the foregoing description, the present invention may be particularly suitable for a fire fighting vehicle that may be equipped with a conventional plain water suppression system and also assist to produce compressed air foam. With this invention, the conversion from a nozzle appropriate for the plain water use to a nozzle appropriate for use with the compressed air foam could be made coincident with the activation of the controls initiated to compress air foam system.

While several forms of the invention have been shown and/or described, other changes and modifications will be appreciated by those skilled in the relevant art. Therefore, it will be understood that the embodiment shown in the drawings and described above are merely for illustrative purposes, and are not intended to limit the scope of the invention which is defined by the claims which follow as interpreted under the principles of patent law including the doctrine of equivalents.

The embodiments of the invention in which an exclusive property right or privilege is claimed are defined as follows:

1. A fire fighting fluid delivery device comprising:
a device body with an inlet, a discharge outlet, and a fluid passageway extending between said inlet and said discharge outlet; and
a movable member mounted at said body and movable between at least two positions relative to said outlet, said movable member having at least two spaced apart transverse openings, and each of said transverse openings for selectively aligning with said discharge outlet when said movable member is moved between said at least two positions.

2. The fire fighting fluid delivery device according to claim 1, further comprising a coupler mounted at each of said transverse openings, said couplers adapted for mounting nozzles to said movable member.

3. The fire fighting fluid delivery device according to claim 2, further comprising a piston at said outlet, said couplers each having an inlet opening and an outlet opening, and said piston movable to seal around said inlet opening of a respective coupler to thereby provide a seal between said respective coupler and said device body when said respective coupler is aligned with said outlet and fluid flows through said device.

4. The fire fighting fluid delivery device according to claim 1, wherein said movable member is mounted generally orthogonal to said discharge outlet.

5. The fire fighting fluid delivery device according to claim 4, wherein said movable member is mounted for linear movement across said discharge outlet.

6. The fire fighting fluid delivery device according to claim 5, wherein said movable member is mounted for horizontal linear movement.

7. The fire fighting fluid delivery device according to claim 1, wherein said movable member includes stops for delineating when a respective transverse opening is aligned with said discharge outlet.

8. The fire fighting fluid delivery device according to claim 1, further comprising an actuator for selectively moving said movable member.

9. The fire fighting fluid delivery device according to claim 8, wherein said actuator comprises a cylinder, such as a pneumatic or hydraulic cylinder, or an electrical actuator.

10. The fire fighting fluid delivery device according to claim 1, further comprising bearings at said discharge outlet of said device body, said bearings supporting said movable member for movement relative to said outlet.

11. The fire fighting fluid delivery device according to claim 1, wherein said fire fighting fluid delivery device comprise a monitor.

12. A fire fighting fluid delivery device comprising:
a device body with an inlet, a discharge outlet, and a fluid passageway extending between said inlet and said outlet; and
a piston mounted at said discharge outlet, said piston having a sealing surface facing outwardly from said discharge opening for sealing against a nozzle or nozzle coupler, when fluid flows through said passageway said piston having an engaged state for sealing against a nozzle or nozzle coupler positioned adjacent said discharge outlet and a non-engaged state when the fluid flow stops or is significantly reduced wherein said piston is non longer urged to seal against the nozzle coupler or nozzle wherein the nozzle or nozzle coupler may be changed.

13. The fire fighting fluid delivery device according to claim 12, further comprising a movable member mounted at said discharge outlet of said device body, said movable member having at least two spaced apart transverse openings, and each of said transverse openings for selectively aligning with said discharge outlet when said movable member is moved between said at least two positions.

14. The fire fighting fluid delivery device according to claim 13, wherein said movable member is mounted generally orthogonal to said discharge outlet.

15. The fire fighting fluid delivery device according to claim 13, wherein said movable member is mounted for linear movement across said discharge outlet.

16. The fire fighting fluid delivery device according to claim 15, wherein said movable member is mounted for horizontal linear movement.

17. The fire fighting fluid delivery device according to claim 15, wherein said movable member includes stops for delineating when a respective transverse opening is aligned with said discharge outlet.

18. The fire fighting fluid delivery device according to claim 13, further comprising an actuator for selectively moving said movable member.

19. The fire fighting fluid delivery device according to claim 15, further comprising bearings at said outlet, said bearings supporting said movable member for movement relative to said outlet.

20. The fire fighting fluid delivery device according to claim 12, wherein said piston comprises an annular member.

21. The fire fighting fluid delivery device according to claim 15, further comprising a coupler at each of said openings for mounting at nozzle at each of said openings, each coupler having an inlet opening and an outlet opening, said movable member mounted to said device body over said piston, and said piston movable to seal around said inlet opening of a respective coupler to thereby provide a seal between said respective coupler and said device body when said respective coupler is aligned with said outlet and fluid flows through said monitor.

22. The fire fighting fluid delivery device according to claim 12, wherein said fire fighting fluid delivery device comprises monitor.

23. A nozzle changer comprising:
a nozzle support member with at least two transverse openings extending therethrough;
a nozzle coupler adapted for mounting a nozzle to said nozzle support member located and supported in each of said openings, each of said couplers having a sealing surface for sealing against an outlet of a fire fighting fluid delivery device; and
an actuator coupled to said support member for moving said support member.

24. The nozzle changer according to claim 23, wherein said couplers comprise threaded couplers.

25. The nozzle changer according to claim 23, wherein each of said couplers has a proximal end and a distal end, said proximal end is mounted in said support member and forming said sealing surfaces, said support member having opposed surfaces, said proximal end being substantially flush with one of said opposed surfaces, and said distal ends projecting from the other of said opposed surfaces for mounting a nozzle to said support member.

26. The nozzle changer according to claim 23, wherein said nozzle support member comprises a rectangular plate.

27. A fire fighting fluid delivery device comprising:
a device body with an inlet, an outlet, and a fluid passageway extending between said inlet and said outlet; and
a remotely controlled nozzle changer mounted at the body, and said changer including at least two nozzles movable relative to said outlet of said device body.

28. The fire fighting fluid delivery device according to claim 27, wherein said nozzle changer comprises a movable member with at least two transverse openings, said nozzles mounted at said openings, and said movable member supported for movement between at least two positions wherein each respective transverse opening and nozzle is aligned with the outlet of said device body.

29. The fire fighting fluid delivery device according to claim 28, wherein said movable member is mounted for lateral linear movement across said outlet.

30. The fire fighting fluid delivery device according to claim 28, further comprising an actuator, wherein said actuator is adapted to be remotely controlled.

31. A method of changing a nozzle on a fire fighting fluid delivery device, the fire fighting fluid delivery device having a device body with an inlet, an outlet, and a fluid passageway extending between said inlet and the outlet, said method comprising:
movably mounting at least two nozzles adjacent the outlet;
moving the nozzles to align one of the nozzles with the outlet; and
sealing the aligned nozzle with the device body at the outlet.
